(19) United States
(12) Patent Application Publication
(10) Pub. No.: US 2002/0138466 A1
(43) Pub. Date: Sep. 26, 2002

(54) Method, computer program and data processing system for data clustering

(75) Inventors: Andreas Arning, Rottenburg (DE); Juergen Jaeger, Andernach (DE); Christoph Lingenfelder, Herrenberg (DE); Oliver Schmidt, Leinfelden (DE)

Correspondence Address: IBM CORPORATION, 3039 CORNWALLIS RD., DEPT. T81 / B503, PO BOX 12195, REASEARCH TRIANGLE PARK, NC, 27709, US

(73) Assignee: International Business Machines Corporation, Armonk, NY

(21) Appl. No.: 10/044,782

(22) Filed: Jan. 11, 2002

(30) Foreign Application Priority Data
Jan. 13, 2001 (EP) 01100792.9

(51) Int. Cl. G06F 7/00

(52) U.S. Cl. 707/1

(57) ABSTRACT

A technique for determining an objective quality index for the result of a clustering operation is disclosed. This technique can be used to evaluate the result of different clustering algorithms or can itself be the basis for an iterative clustering algorithm. The invention can be implemented by means of a computer program running on a data processing system which can have parallel processing units for performing different clustering algorithms in parallel.

### BACKGROUND OF THE INVENTION

1. Field of Invention

The present invention relates to the field of data clustering and in particular to clustering algorithms and quality determination.

2. Description of the Related Art

Clustering of data is a data processing task in which clusters are identified in a structured set of raw data. Typically, the raw data consists of a large set of records, each record having the same or a similar format. Each field in a record can take any of a number of logical, categorical, or numerical values. Data clustering aims to group such records into clusters such that records belonging to the same cluster have a high degree of similarity.

A variety of algorithms is known for data clustering. The K-means algorithm relies on the minimal sum of Euclidean distances to centers of clusters, taking into consideration the number of clusters. The Kohonen algorithm is based on a neural net and also uses Euclidean distances. IBM's demographic algorithm relies on the sum of internal similarities minus the sum of external similarities as a clustering criterion. Those and other clustering criteria are utilized in an iterative process of finding clusters.

A common disadvantage of such prior art clustering algorithms is that different clustering algorithms applied to the same set of data may deliver largely different results. Even if the same algorithm is applied to the same set of data using a different set of parameters as a starting condition, a different result is likely to occur. In the prior art, no objective criterion exists to compare the results of such clustering operations.

One field of application of data clustering is data mining. U.S. Pat. No. 6,112,194 describes a technique for data mining including a feedback mechanism for monitoring performance of mining tasks. A user-selected mining technique type is received for the data mining operation. A quality measure type is identified for the user-selected mining technique type. The user-selected mining technique type for the data mining operation is processed and a quality indicator is measured using the quality measure type. The measured quality indication is displayed while processing the user-selected mining technique type for the data mining operations.

U.S. Pat. No. 6,115,708 describes a method for refining the initial conditions for clustering with applications to small and large database clustering. How this method is applied to the popular K-means clustering algorithm and how refined initial starting points indeed lead to improved solutions are described. The technique can be used as an initializer for other clustering solutions. The method is based on an efficient technique for estimating the modes of a distribution and runs in time guaranteed to be less than overall clustering time for large data sets. The method is also scalable and hence can be efficiently used on huge databases to refine starting points for scalable clustering algorithms in data mining applications.

U.S. Pat. No. 6,100,901 describes a method for visualizing a multi-dimensional data set in which the multi-dimensional data set is clustered into k clusters, with each cluster having a centroid. Either two distinct current centroids or three distinct non-collinear current centroids are selected. A current 2-dimensional cluster projection is generated based on the selected current centroids. In the case when two distinct current centroids are selected, two distinct target centroids are selected, with at least one of the two target centroids being different from the two current centroids.

U.S. Pat. No. 5,857,179 describes a computer-implemented technique for clustering documents and automatic generation of cluster keywords. An initial document by term matrix is formed, each document being represented by a respective M dimensional vector, where M represents the number of terms or words in a predetermined domain of documents. The dimensionality of the initial matrix is reduced to form resultant vectors of the documents. The resultant vectors are then clustered such that correlated documents are grouped into respective clusters. For each cluster, the terms having greatest impact on the documents in that cluster are identified. The identified terms represent key words of each document in that cluster. Further, the identified terms form a cluster summary indicative of the documents in that cluster.

### SUMMARY OF THE INVENTION

A principal object of the present invention is to provide a method, data processing system and computer program product for data clustering and quality determination such that the qualities of clustering results can be compared on an objective basis. The quality index for a clustering result obtained in accordance with the invention is independent of the clustering algorithm used.

Rather than relying on the clustering algorithm itself for quality determination, the invention relies on a statistical analysis of the clustering result to determine the quality of the clustering. The statistical analysis uses a comparison of the foreground and background frequencies of buckets. The comparison results in a statistical parameter used to calculate a quality index.

According to a preferred embodiment, the quality index is normalized such that even if different sets of data are used as a basis for different clustering operations, the results of the clustering are still comparable based on the objective quality index.

According to a further preferred embodiment of the invention, a clustering operation is carried out by performing a data clustering operation based on a variety of different clustering algorithms either in parallel or sequentially, determining the qualities of the respective clustering results and ranking the results accordingly. The result with the highest quality index can be considered the overall result of the clustering operation.

Further, the invention provides a clustering algorithm relying on an objective quality index to be optimized in a number of iterations. This algorithm outputs a resulting quality index for its clustering result which is objective and can be compared to corresponding other results.

A method of the invention is advantageously implemented in a data processing system by means of a corresponding computer program. If a number of different clustering algorithms is used, it is advantageous to assign a dedicated processing unit of the data processing system to each clustering algorithm for the purpose of parallel processing. This has the advantage of minimizing the processing time required.

### BRIEF DESCRIPTION OF THE DRAWINGS

The present invention together with the above and other objects and advantages may best be understood from the following description of the preferred embodiments of the invention as illustrated in the drawings, wherein:

FIG. 1 is a schematic representation of the structure of a cluster j;

FIG. 2 is a flow chart illustrating a preferred embodiment of the determination of a quality index;

FIG. 3 is a flow chart illustrating the utilization of different clustering algorithms in parallel;

FIG. 4 is a flow chart illustrating a clustering algorithm relying on an objective criterion to be optimized in a number of iterations; and

FIG. 5 is a block diagram showing the structure of a data processing system.

### DESCRIPTION OF THE PREFERRED EMBODIMENT

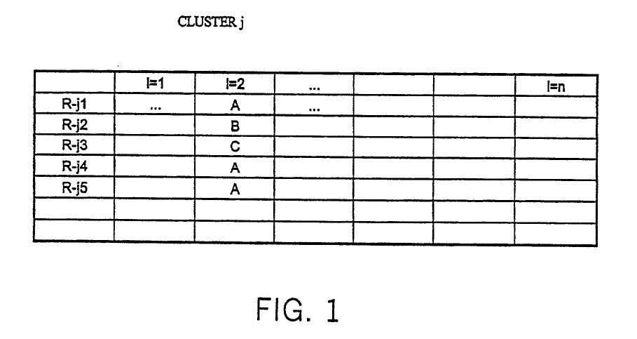

FIG. 1 shows a number of records R-j1, R-j2, . . . , R-j5 in a cluster j. Each record has a number of fields n. Each field stores a variable L. Each variable can take a certain number of states. Each such state is called a bucket, i.e., a value the variable can take. There are different types of variables such as logical, categorical, and numerical variables. An example of a categorical variable is the gender of a person. In this case, the two corresponding buckets are “male” and “female”. In the case of numerical variables, typically the spectrum of the numeric range is separated into sub-ranges, each sub-range defining a bucket of the variable.

The raw data on which the data clustering operation is applied consists of a large volume of such structured data records. The result of a clustering operation yields a number k of clusters of which the cluster j is schematically depicted in the example of FIG. 1.

The variable l=2 has the value A in the record R-j1. In other words, the bucket i=1 for the variable l=2 in the record R-j1 equals A. Other than A, the variable l=2 can also take values B or C, i.e., the bucket i=2 is B and the bucket i=3 for this variable l=2 is B and C, respectively. For example, in the record R-j3 of the cluster j, the variable l=2 has the bucket C(i=3), and in the record R-j4 of the cluster j, the variable l=2 has the bucket A again(i=1).

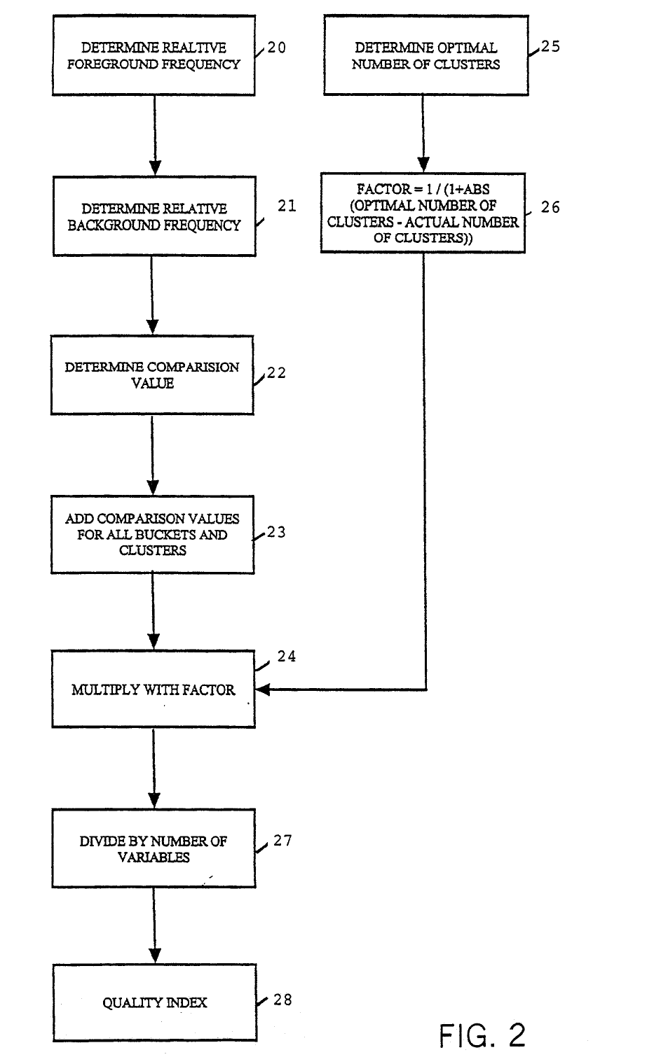

With respect to FIG. 2, a preferred embodiment of a method for determining a quality index for a clustering result is now explained in more detail. In Step 20, the relative foreground frequency of a bucket i of the variable l is determined for the cluster j. For example, the relative foreground frequency of the bucket i=1 for the variable l=2 in the cluster j of the example shown in FIG. 1 is ⅗, as the bucket i=1 for this variable, which is A, occurs three times in the total of the five records contained in the cluster j.

In the next Step 21, the relative background frequency of the bucket i of the variable l is determined for all clusters, i.e., for the entire set of records contained in the clustered data. In the example considered with respect to FIG. 1, this is done by determining the number of occurrences of the bucket i=1 for the variable l=2 in all records and dividing the absolute number of occurrences by the number of all records.

In Step 22, a comparison value is determined to compare the relative foreground and background frequencies resulting from steps 20 and 21. The comparison can be performed by subtracting the relative foreground and background frequencies for a given bucket i of a given variable l. This is reflected in the following equation:

f_{j,i,l}−v_{i,l} (1)

where f_{j,i,l} is the relative foreground frequency of the bucket i of the variable l in the cluster j and v_{i,l} is the relative background frequency of the bucket i of the variable 1. This subtraction yields a parameter which is representative of the differentiation of the cluster j in comparison to all other clusters as far as the bucket i of the variable l is concerned. As the result of the subtraction can be negative, it is advantageous to either square the result:

(f_{j,i,l}−v_{i,l})² (2)

or to determine the absolute value of the result:

|f_{j,i,l}−v_{i,l,}|. (3)

In Step 23, these comparison values are determined and than added for all buckets i in all clusters j for a given variable l according to the following equation:

$${r}_{l} = {\sum }_{j = 1}^{k} {\sum }_{i = 1}^{m} {( {f}_{j , i , l} - {v}_{i , l} )}^{2} \qquad ( 4 )$$

The resulting parameter rₗ is multiplied with a factor in Step 24. The factor is determined in steps 25 and 26. In Step 25, the optimal number of clusters (optClust) is determined. For example, the optimal number of clusters can be defined to be equal to the maximum number of buckets of any of the variables. It is advantageous to set a threshold value for the optimal number of clusters in case one of the variables has a very large number of buckets or if the maximum number of clusters is dictated by the purpose of the clustering operation. For example, if the clustering is performed to identify demographic groups of people for group oriented advertisement typically not more than ten clusters corresponding to ten different marketing campaigns or segments are desirable.

In Step 26, the factor is calculated based on the optimal number of clusters and the actual number of clusters. The actual number of clusters is the number of clusters resulting from the clustering operation.

In Step 27, a division by the number of variables n is performed. The summation of the parameter rₗ for all variables l yields the quality index QI according to the following equation:

$$QI = \frac{1}{n} * {\sum }_{l = 1}^{n} {r}_{l} * \frac{min [ opt Clust , Nbr Clust ]}{max [ opt Clust , Nbr Clust ]} \qquad ( 5 )$$

where min[optClust,NbrClust] is the smaller number of optClust and NbrClust and max[optClust,NbrClust]is the bigger number.

The quality index QI is outputted in step 28.

According to a further preferred embodiment of the invention a normalizing value is determined to make the quality index independent of the data to which the clustering operation is applied. This has the advantage that even if clustering operations are performed on a different set of data, the quality of the results is still comparable. The normalizing value 0ₗ for a given variable l is determined in accordance with the following equation:

$${o}_{l} = {\sum }_{i = 1}^{m} {( 1 - {v}_{i , l} )}^{2} + ( k - 1 ) {\sum }_{i = 1}^{m} {( {v}_{i , l} )}^{2} \qquad ( 6 )$$

The equation 6 corresponds to the above equation 4 for the case of an imaginary situation where in one of the clusters the relative foreground frequency of a bucket is equal to one and equal to zero for all other clusters. In other words, All records containing the bucket are concentrated in the same cluster. This cluster corresponds to the first summation term in equation 6; all the other clusters are represented by the second summation term multiplied by the number of clusters k minus 1.

This way the normalized quality index is determined in accordance with following equation:

$$QI = \frac{1}{n} * {\sum }_{l = 1}^{n} \frac{{r}_{l}}{{o}_{l}} * \frac{min [ opt Clust , Nbr Clust ]}{max [ opt Clust , Nbr Clust ]} \qquad ( 7 )$$

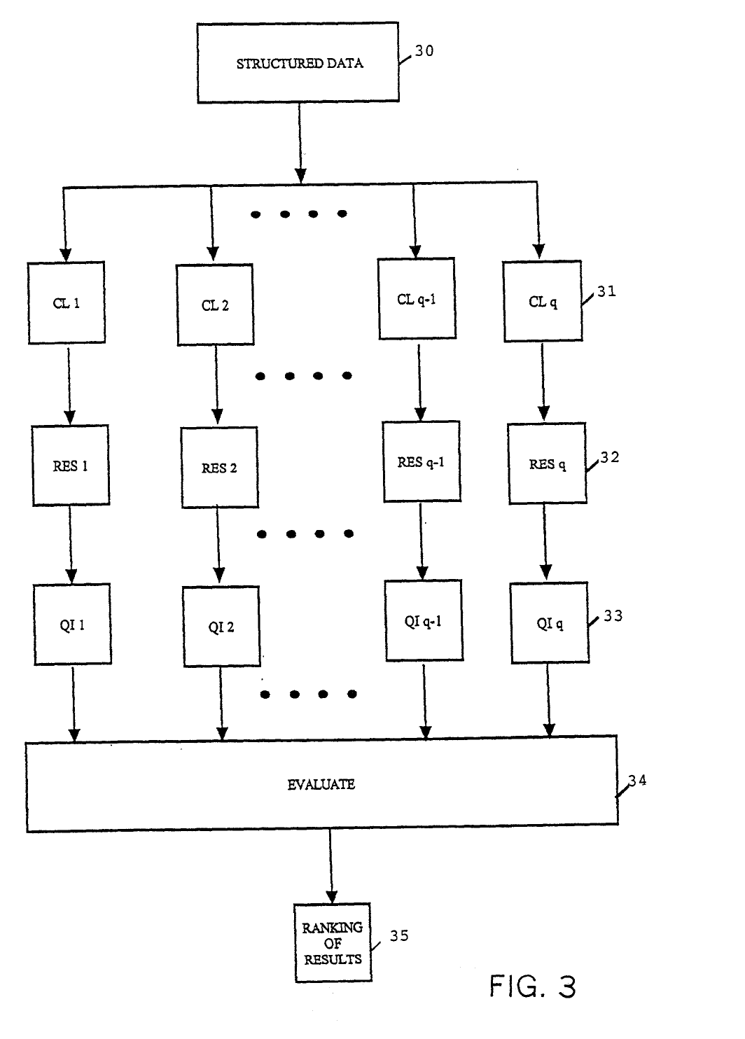

FIG. 3 shows an example of an application of the method of FIG. 2 for performing a clustering of structured data 30 comprising records similar to the records of FIG. 1. The clustering algorithms CL 1, CL 2 . . . CL q are applied on the data 30. This yields the clustering results RES 1, RES 2 . . . RES q. For each of the results, a corresponding quality index QI 1, QI 2, . . . QI q is determined in accordance with the method of FIG. 2. This is done by means of parallel data processing in Steps 31, 32 and 33, respectively.

In Step 34, the quality indices QI 1, QU 2, . . . QU q are evaluated by numeric comparison. The numeric comparison of the quality indices results in an ordered list of the quality indices corresponding to a ranking of the respective results. The comparison of the quality of the results is made possible by the invention because it allows to determine an objective quality index for each result purely based on a statistical analysis of the result without relying on the clustering algorithm used to obtain the result.

The ranking of the result is outputted in Step 35. The result with the highest quality index QI can be considered the overall end result of the data clustering operation of FIG. 3.

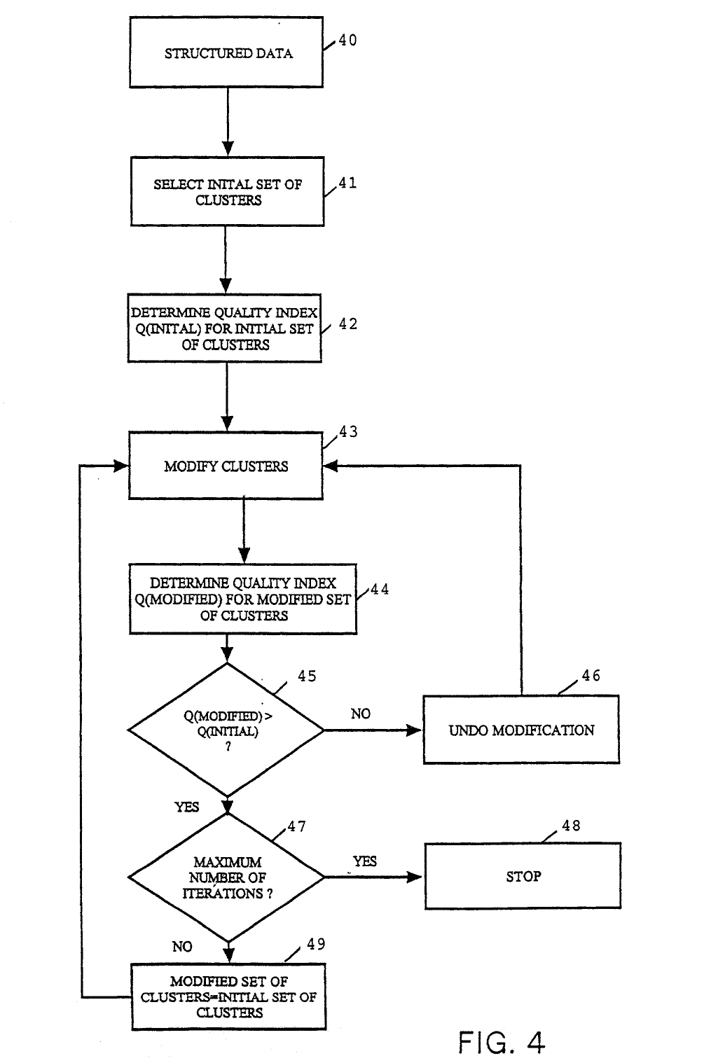

With respect to FIG. 4, a clustering method being based on the objective quality index of the invention is shown in more detail. The clustering method is applied to a set of structured data 40 comprising records substantially similar to the example FIG. 1. In Step 41, a convenient initial set of clusters is selected. This can be done by using any of the known clustering methods. In Step 42, the quality index Q(initial) for the initial set of clusters is calculated in accordance with equation (5) or (7).

In Step 43, the initial set of clusters is modified by moving one or more records from their clusters to other clusters. In Step 44, the quality index Q(modified) for the modified set of clusters is calculated in accordance with equation (5) or (7).

In Step 45, it is decided whether the quality index Q(modified) is greater than the quality index Q(initial). If this is not the case, this implies that the quality of the clustering did not improve. As a consequence, the modification previously performed in Step 43 is reversed in Step 46 and the control returns to Step 43 to perform a different modification.

In case the result of Step 45 is that in fact Q(modified) is greater than Q(initial) and thus the quality of the clustering increased, control of the process goes to Step 47.

In Step 47, it is decided if the actual number of iterations has been reached. If this is the case, the execution of the program stops in Step 48. If the contrary is the case, in Step 49 the modified set of clusters is declared to be the initial set of clusters for a further iteration step. This way the quality of the clustering is gradually increased until it reaches an ideal value or the operation is stopped after a predetermined number of iterations.

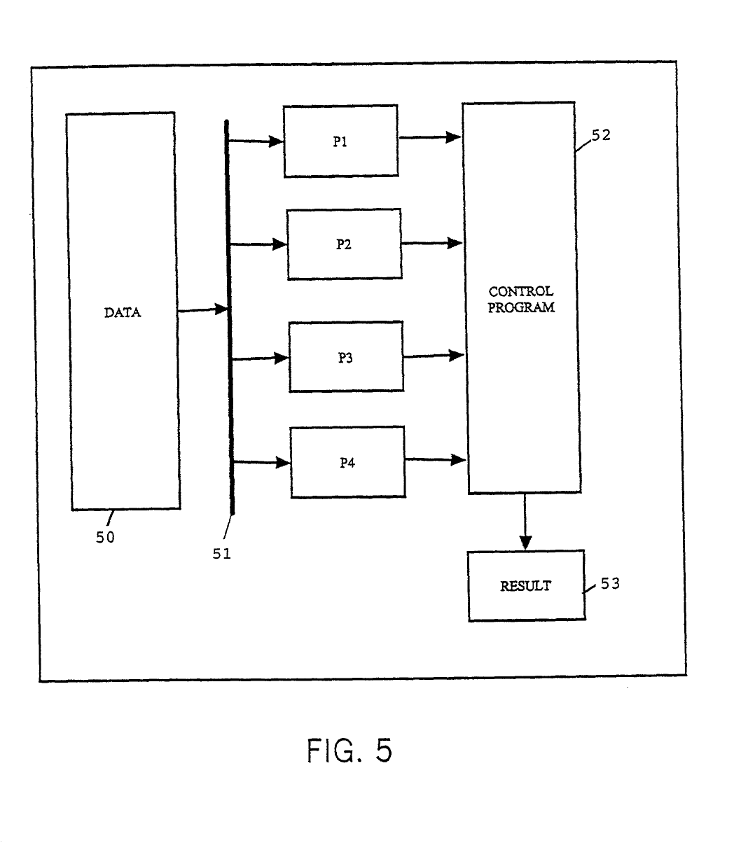

FIG. 5 shows a schematic block diagram of a preferred embodiment of a data processing system in accordance with the invention. The data processing system has a database 50 for storage of structured data. The database 50 is connected to a number of parallel processing units P1, P2, P3 and P4 via data bus 51. In each of the processing units P1 to P4, a data clustering operation is performed based on a variety of data clustering algorithms. The corresponding results are outputted to a control program stored in memory 52. The control program determines a quality index for each clustering result obtained by the parallel processing units P1 to P4. This is done in accordance with the preferred embodiments of FIG. 2 and FIG. 3. The clustering result with the highest quality index value is selected by the control program and outputted as result 53.

1. A method for determining the quality of a result of a clustering data processing operation, the result comprising a set of clusters, a cluster having a set of buckets for each variable, the method comprising the steps of:
a) determining a foreground frequency of a bucket within a first cluster;
b) determining a background frequency of the bucket with respect to all of the clusters;
c) comparing the foreground and background frequencies; and
d) determining a quality index based on the comparison.

2. The method of claim 1, wherein said comparing step further comprises subtracting the relative foreground and background frequencies.

3. The method of claim 2, wherein said comprising step further comprises squaring the result of the comparison.

4. The method of claim 1, further comprising the steps of:
e) determining an optimal number of clusters; and
f) comparing the optimal number of clusters to the actual number of clusters resulting from the clustering date processing operation

5. The method of claim 4, wherein the optimal number of clusters is determined by a maximum number of buckets for a variable.

6. The method of claim 5, wherein the optimal number of clusters is set to a threshold value in case the maximum number of buckets is greater than the threshold value.

7. The method of claim 4, further comprising the steps of:
g) determining a factor based on the optimal number of clusters and the actual number of clusters; and
h) multiplying the result of the comparison of the relative foreground and background frequencies with the factor.

8. The method of claim 7, further comprising the steps of:
i) determining a normalizing value being independent of any correlations between fields of the data on which the data processing operation is applied; and
j) normalizing the result of the comparison of the foreground and background frequencies by means of the normalizing value.

9. The method of claim 8, wherein said step of determining the normalizing value further comprises:
i) comparing the background frequencies of the buckets with an imaginary cluster having a foreground frequency of the bucket equal to one;
ii) comparing the background frequencies of the buckets with an imaginary cluster having a foreground frequency of the bucket equal to zero; and
iii) summing the results of the corresponding comparison values.

10. A method for data clustering, said method comprising the steps of:
a) performing a number of data clustering operations;
b) determining a quality index for each result of the data clustering operations; and
c) selecting the result with the highest quality index as an end result of the data clustering.

11. A method for data clustering, said method comprising the steps of:
a) selecting an initial set of clusters;
b) determining a quality index for the clusters; and
c) performing a number of iterations to improve the quality index.

12. The method of claim 11, further comprising the steps of:
d) moving at least one record of at least one of the clusters to another cluster;
e) determining the quality index for the modified clusters; and
f) using the modified clusters as a new initial set of clusters in case the quality index improved.

13. A computer program product stored on a computer usable medium for determining the quality of a result of a clustering data processing operation, the result comprising a set of clusters, a cluster having a set of buckets for each variable, the method comprising the said program product comprising:
determining first subprocesses for a foreground frequency of a bucket within a first cluster;
determining second subprocesses for a background frequency of the bucket with respect to all of the clusters;
comparing third subprocesses the foreground and background frequencies; and
determining fourth subprocesses a quality index based on the comparison.
